(19) United States
(12) Patent Application Publication
(10) Pub. No.: US 2020/0374202 A1
(43) Pub. Date: Nov. 26, 2020

(54) INDUSTRIAL FIELD SERVICES AUTOMATION PLATFORM

(71) Applicant: AM Technologies Inc., Sterling, VA (US)

(72) Inventors: Somjit Amrit, Chennai (IN); Muralidharan Neelameghan, Chennai (IN)

(73) Assignee: AM Technologies Inc., Sterling, VA (US)

(21) Appl. No.: 16/866,351

(22) Filed: May 4, 2020

Related U.S. Application Data
(60) Provisional application No. 62/851,817, filed on May 23, 2019.

(51) Int. Cl. H04L 12/24

(52) U.S. Cl. CPC H04L 41/5041; H04L 41/5074; H04L 41/0631

(57) ABSTRACT

A system comprising a sensor hub and a field service platform coupled to the sensor hub, for remote monitoring and servicing of industrial equipment. The sensor hub is coupled with a plurality of sensors and comprises a first circuitry that is configured to obtain sensor data associated with the at least one industrial equipment, from the plurality of sensors, detect one or more exceptions in the sensor data, provide exception management via edge intelligence based on the detected one or more exceptions, and transmit one or more of the sensor data or the detected one or more exceptions. The field service platform comprises a second circuitry configured to process the one or more of the sensor data or the detected one or more exceptions received from the sensor hub, and generate service assistance information to resolve the processed one or more exceptions associated with the at least one industrial equipment.

### TECHNOLOGICAL FIELD

The present disclosure generally relates to field service operation management and more particularly relates to smarter and automated industrial field service operation management.

### BACKGROUND

Field service operations, such as, inventory maintenance, billing, accounting, asset management, scheduling and dispatching, maintenance of industrial equipment, etc., are vital for functioning of any enterprise. Efficiently managing a team of field technicians in performing the field service operations is a complex task, based on multiple variables, such as, availability, proximity, competency of the field technicians, etc.

In the case of maintenance of industrial equipment, the health of the industrial equipment is, typically, monitored by a plurality of sensors. The plurality of sensors may continuously or intermittently monitor the condition of the industrial equipment, as configured. In the existing setups of maintenance of industrial equipment, the burden of determining an anomaly in the industrial equipment lies in a cloud platform with limited or no edge intelligence. All the sensor data from the industrial equipment needs to be communicated to the cloud platform to determine the anomaly, thus bringing inherent latency and consuming a significant bandwidth of a communication network, such as, Wi-Fi® of Wi-Fi Alliance Corporation, LTE® of European Telecommunications Standards Institute, etc. Furthermore, for maintenance of the industrial equipment, the field technicians may be manually allocated by an administrative team, based on their availability, proximity, and competency/experience etc. The task of allocation to the field technicians is a cumbersome and tedious job for the administrative team. Such allocation of the jobs to the field technicians may also be performed using a standalone ticketing system. The standalone ticketing system allocates the jobs to the field technicians based on their availability, proximity, and/or competency/experience of the field technicians to the industrial equipment. The standalone ticketing system or the manual allocation of tickets or tasks by the administrative team may result in the jobs being wrongly allocated to field technicians, thus being detrimental to the safety and smooth functioning of the enterprise.

Hence, there exists a long felt need for a field service platform for remote monitoring of industrial equipment and smarter resolution of anomalies or exceptions in the industrial equipment though intelligent and appropriate allocation of filed technicians.

### BRIEF SUMMARY

A system, a method, and a computer program product is provided herein that focuses on providing remote monitoring and servicing of at least one industrial equipment. A system, that is, an industrial field services automation (IFSA) platform is provided for remote monitoring and automated resolution of exceptions associated with industrial equipment. A combination of the IFSA platform and an internet of things (IoT) application on a user device automates and improves remote monitoring of the industrial equipment and over time generates crucial insights about the health of the industrial equipment. The IFSA platform is a combination of a smart sensor hub and a field services cloud. The smart sensor hub is capable of connecting to a plurality of sensors monitoring different parameters associated with the industrial equipment and possesses edge intelligence for local processing and analysis of sensor data. The field services cloud performs remote analysis of the sensor data and performs smarter field service operation management in resolution of exceptions associated with industrial equipment.

In one aspect, a system, that is an industrial field services automation (IFSA) platform, is for remote monitoring and servicing of at least one industrial equipment. The IFSA platform comprises a sensor hub, that is, a smart sensor hub and a field service platform, that is, a field service cloud. The sensor hub is removably coupled with a plurality of sensors. The sensor hub comprises a first circuitry that is configured to obtain sensor data associated with the at least one industrial equipment, from the plurality of sensors, detect one or more exceptions in the sensor data obtained from the plurality of sensors, provide exception management through edge intelligence based on the detected one or more exceptions and transmit the sensor data or the one or more alerts based on a mode of operation of the sensor hub. The mode of operation of the sensor hub is at least one of manual mode, an environmental mode, or a temporal mode. The first circuitry is configured to determine a degree of the one or more exceptions and generate one or more alerts to provide exception management. The first circuitry is further configured to clone a schema of the detected one or more exceptions using digital twinning.

The field service platform is communicatively coupled to the sensor hub. The field service platform comprises a second circuitry configured to process the sensor data, or the one or more alerts received from the sensor hub and generate service assistance information to resolve the one or more alerts/exception/anomaly associated with the at least one industrial equipment. The service assistance information comprises one or more of suggestions, recommendations, or troubleshooting manuals associated with the one or more processed exceptions.

To generate service assistance information, the second circuitry is configured to generate one or more tickets corresponding to the processed one or more alerts associated with the at least one industrial equipment, and select a field service agent corresponding to the generated one or more tickets based on a service profile curated over a period of time and the services rendered of the field service agent stored in a distributed ledger.

The second circuitry is further configured to generate navigation data on one or more user devices associated with the selected field service agent to navigate to a location of the at least one industrial equipment detected with the one or more exceptions and render the navigation data and the service assistance information on a user interface of each of the one or more user devices associated with the selected field service agent. The second circuitry is further configured to update the service profile of the field service agent, corresponding to the generated one or more tickets, in the distributed ledger.

The second circuitry is further configured to generate at least one of a workforce management interface, a ticket management interface, an alert interface, or a field operations interface with a workflow and an escalation matrix. The second circuitry is further configured to initialize a routine for auto-resolution of the one or more exceptions in the at least one industrial equipment.

In another aspect, a method for providing remote monitoring and servicing of at least one industrial equipment is provided. The method may include obtaining sensor data associated with the at least one industrial equipment, from a plurality of sensors coupled removably in a plug and play mode with a sensor hub. The method may include detecting one or more exceptions in the sensor data obtained from the plurality of sensors and providing exception management through edge intelligence based on detected one or more exceptions. The exception management comprises determining a degree of the one or more exceptions; and generating one or more alerts associated with the one or more exceptions based on the degree of the one or more exceptions. The method may further include transmitting the sensor data or the one or more alerts based on a mode of operation of the sensor hub. The method may include processing one or more of the sensor data or the one or more alerts associated with the at least one industrial equipment, and further generating service assistance information to resolve the processed one or more exceptions associated with the at least one industrial equipment.

In yet another aspect, a computer programmable product for remote monitoring and servicing of at least one industrial equipment is provided. The computer programmable product comprises a non-transitory computer readable medium having stored thereon computer executable instructions, which when executed by one or more processors, cause the one or more processors to carry out operations for providing remote monitoring and servicing of at least one industrial equipment. The operations comprise obtaining sensor data associated with the at least one industrial equipment, from a plurality of sensors coupled removably with a sensor hub, and detecting one or more exceptions in the sensor data obtained from the plurality of sensors and providing exception management through edge intelligence based on the detected one or more exceptions. The exception management comprises determining a degree of the one or more exceptions; and generating one or more alerts associated with the one or more exceptions based on the degree of the one or more exceptions. The operations may further include transmitting the sensor data or the one or more alerts based on a mode of operation of the sensor hub. The operations may include processing one or more of the sensor data or the one or more alerts associated with the at least one industrial equipment, and further generating service assistance information to resolve the processed one or more exceptions associated with the at least one industrial equipment.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates an architectural diagram of a smartplace with an implementation of an industrial field services automation (IFSA) platform, in accordance with one or more example embodiments;

FIG. 2 illustrates an architectural diagram of a smart sensor hub of the IFSA platform, in accordance with one or more example embodiments;

FIG. 3 illustrates a schematic diagram of data transmission by the smart sensor hub of the IFSA platform, in accordance with one or more example embodiments;

FIG. 4 illustrates an architectural diagram of a field service cloud of the IFSA platform, in accordance with one or more example embodiments;

FIG. 5 exemplarily illustrates a method for remote monitoring and servicing of at least one industrial equipment, in accordance with an example embodiment;

FIGS. 6A-6C illustrate user interfaces rendered by the field service cloud on a user device, in accordance with one or more example embodiments;

FIG. 7 illustrates a schematic diagram for implementation of smartplace using the IFSA platform, in accordance with one or more example embodiments; and

FIG. 8 illustrates a schematic diagram showing different applications of the industrial field services automation (IFSA) platform, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, apparatuses and methods are shown in block diagram form only in order to avoid obscuring the present disclosure.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present invention. Thus, use of any such terms should not be taken to limit the spirit and scope of embodiments of the present invention.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

An industrial field services automation (IFSA) platform is provided in accordance with an example embodiment described herein for remote monitoring and automated resolution of exceptions associated with an industrial equipment. The IFSA platform performs field service management utilizing Internet of Things (IoT) technology. The IFSA platform is a smart and secured IoT platform powered with machine learning (ML) and analytics for remote monitoring of the industrial equipment and machine-machine workforce automation. The IFSA platform is a cross industry platform and sensor data from any industrial equipment may be configured using extensible library of adaptors. The IFSA platform automates and improves remote monitoring solution, boosts agility, and generates crucial insights about the functioning of the industrial equipment, thereby enabling decision making by the enterprise field service management enabled through IoT

The IFSA platform is a combination of a smart sensor hub and a field service cloud functioning in combination with an IoT application deployed on a user device. The IFSA platform monitors the health of industrial equipment, for example, a data center rack using the smart sensor hub. Health of the industrial equipment may be monitored by a plurality of sensors. The sensors are physically connected to the smart sensor hub that transforms the industrial equipment into a cyber-physical connected intelligent equipment. The smart sensor hub has a plurality of external connection ports, for example, six external connection ports to sense different parameters, such as, temperature, pressure, humidity, air-flow rate, vibration, etc. The external connection ports of the smart sensor hub allow for connection of sensors that monitor the industrial equipment. The smart sensor hub stores, processes, and analyzes the sensor data generated by the connected sensors and determines occurrence of exceptions in the sensor data. Based on the occurrence of exceptions in the sensor data, the smart sensor hub generates instructions to be communicated to field service agents, such as, field managers, field technicians, etc., via the field service cloud for a speedy and smarter resolution of the exceptions.

The IFSA platform is an IoT platform that is a complete site-to-mobile platform to enable field service management by the field service leaders to take the right decision at the right time. The IFSA platform is a scalable, ruggedized, and efficient IoT platform which uses low power and long-range communication technology across a connect-monitor-act paradigm. The IFSA platform is an end to end integrated IoT platform that provides operational insights for both indoor and outdoor gear supported by field service management personnel, such as, the field technicians. The IFSA platform helps improve service metrics across the lifecycle of field service management operations, such as, resource scheduling, resource allocation, resolution of exceptions, etc. The IFSA platform ensures right field personnel be engaged with full preparation before he/she reaches the industrial equipment. On arrival of the field personnel at the site of the industrial equipment, the IFSA platform guides the field personnel to the exact location of the industrial equipment, reducing the time to locate the industrial equipment. Furthermore, the IFSA platform supports the field service management functions by tracking performance of the industrial equipment and alerting on exceptions and automating the resolution of the exceptions through actuation of auto-resolution routines or competency-based operator selection.

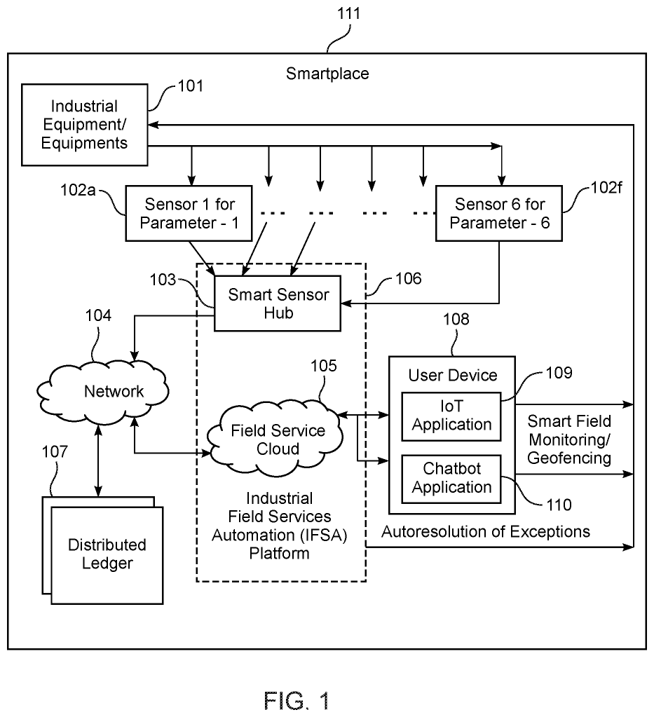

FIG. 1 illustrates an architectural diagram of a smartplace 111 with an implementation of an industrial field services automation (IFSA) platform 106, in accordance with one or more example embodiments. As used herein, a “smartplace” refers to an industry remote monitoring service that integrates sensing and edge processing for cloud based exceptions and is agnostic to field service processes. The smartplace 111 involves an integration of a smart sensor hub 103 with a field service cloud 105 for purposeful actuation of necessary instructions, such as, service assistance information and navigation data, in an application 109 or 110 on a user device 108. The smartplace 111 may be implemented in a datacenter, a smart building, infrastructure of a Telecom service provider, a Hospital, etc. As used herein, a “sensor hub” refers to an aggregator of multiple external sensors 102a-102f that includes a control unit or a processor to compile and process data gathered from the sensors 102a-102f. As used herein, a “smart sensor hub” refers to a sensor hub with edge intelligence (interchangeably referred as “sensor intelligence” or “sensor edge intelligence”). The smart sensor hub 103 aggregates sensor data from the multiple sensors 102a-102f, stores, processes, and analyzes the aggregated sensor data using trained machine learning (ML) model, and transmits the analyzed sensor data with advanced networking capabilities to the field service cloud 105. The smart sensor hub 103 operates in different modes and generates smart alerts. A “field service cloud” refers to a cloud computing platform that uses predictive engine and self-learning to automate and optimize field service operations, such as, scheduling servicing, dispatching deliverables, job allocation, etc. The field service cloud 105 generates instructions to an IoT application 109 and a chatbot application 110 on the user device 108.

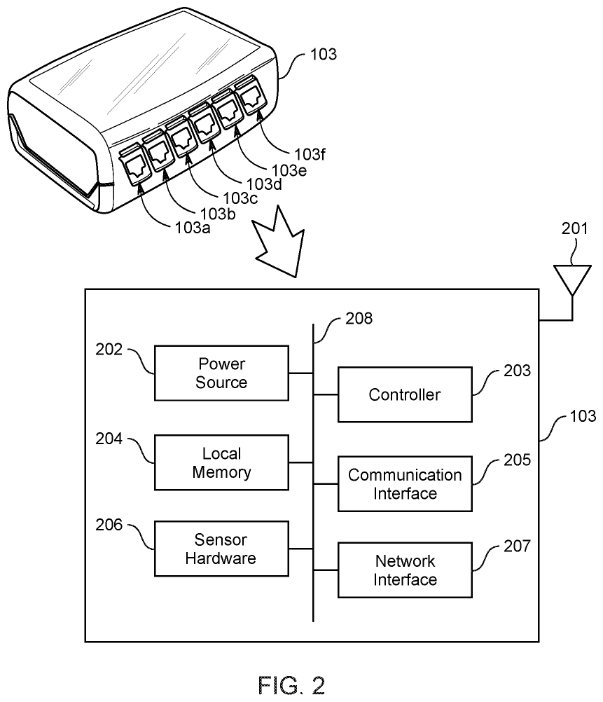

The sensors 102a-102f may be connected to an industrial equipment 101. The industrial equipment 101 may be a data center rack in a datacenter, a base transceiver station in a broadband center of an enterprise, Uninterrupted Power Supply unit (UPS), etc. The sensors 102a-102f may be coupled or be in close proximity of the industrial equipment 101. The sensors 102a-102f may monitor the parameters, such as, current, voltage, temperature, pressure, airflow, humidity, liquid flow, gas emission, etc., associated with the industrial equipment 101 and generate corresponding sensor data. As exemplarily illustrated, the sensors 102a-102f may be communicatively coupled to the smart sensor hub 103 through a plug and play feature of the smart sensor hub 103 and the sensor data may be communicated to the smart sensor hub 103. That is, the smart sensor hub 103 is adaptable or interchangeable to be communicating with one or more sensors, up to six sensors 102a-102f, simultaneously. The smart sensor hub 103 with edge intelligence may store, analyze, and process the generated sensor data to detect exceptions in the generated sensor data. In an embodiment, the IFSA platform 106 may exclude the smart sensor hub 103 and the edge intelligence may lie in one of the sensors, such as, 102a. The plug and play feature of the smart sensor hub 103 is attributed to the connection ports of the smart sensor hub 103 as exemplarily illustrated in FIG. 2. The six sensors 102a-102f, each monitoring a different parameter, may transmit corresponding sensor data to the smart sensor hub 103, when connected to the smart sensor hub 103 via the six connection ports. The plug and play feature of the smart sensor hub 103 allows the smart sensor hub 103 to function smoothly with legacy sensors, such as, 102a-102f. The smart sensor hub 103 is not driven by any particular protocols to allow connection of the legacy sensors, such as, 102a-102f. In an embodiment, the smart sensor hub 103, in addition to the connection ports to connect six sensors, may have three more embedded sensors within its enclosure. The smart sensor hub 103 may be deployed to monitor parameters of the industrial equipment 101 along with the one or more sensors connected to the smart sensor hub 103.

The smart sensor hub 103 may be based on a set of programmed rules to identify exceptions in the regular sensor data. The smart sensor hub 103 may detect exceptions in the sensor data, such as, a sensed ambient temperature less than a threshold value, a sensed humidity measurement greater than a threshold value, etc., and may transmit the exceptions and alerts to the field service cloud 105. The smart sensor hub 103 may operate in different modes, such as, a manual mode, an environmental mode, and a temporal mode. In the temporal mode, the smart sensor hub 103 may be configured to transmit the sensor data by a platform administrator of the IFSA platform 106 to the field service cloud 105. The smart sensor hub 103 may be configured to transmit the sensor data on a regular basis, such as, daily, weekly, monthly, etc. In an embodiment, the sensor data may be transmitted through flexible messaging schemes and configurable file formats. In an embodiment, the smart sensor hub 103 may check for exceptions in the sensor data on a daily basis or a weekly basis to check on the health of the industrial equipment 101. In the manual mode, the smart sensor hub 103 may be accessed manually by the user of the IFSA platform 106, such as, a field technician, field manager, etc., as and when desired. The user of the IFSA platform 106 may access the sensor data received by the smart sensor hub 103 for external processing or for tuning and configuration of the smart sensor hub 103. In the environmental mode, the smart sensor hub 103 may be configured to monitor parameters, such as, vibration, humidity, temperature, etc., using internal sensor probes within the enclosure of the smart sensor hub 103 to determine health of the smart sensor hub 103.

Additionally or alternatively, the field service cloud 105 may use over-the-air (OTA) communication technology to communicate with the sensor hub 103 for sending at least one of an update in the instructions given to the sensor hub 103, an update in a configuration setting of the sensor hub 103, a distribution of a new software, or new update in the existing software running at the sensor hub 103. For example, but not limited to, the field service cloud 105 may send an update in threshold value of heat dissipated by the industrial equipment 101 with respect to an ambient temperature for the respective industrial equipment 101. The ambient temperature of the industrial equipment 101 varies with respect to weather conditions, a number of components surrounding the industrial equipment 101, an amount of heat dissipated by the industrial equipment 101, etc. The amount of heat dissipated by the industrial equipment 101 raises the ambient temperature of the industrial equipment 101, and in hot weather condition the threshold limit of the ambient temperature may reach early as compared to the cold weather condition. Accordingly, threshold limit of the amount of heat dissipated by the industrial equipment 101 in hot weather may be less as compared to cold weather condition. Therefore the amount/level of heat dissipation which triggers an exception for the industrial equipment 101 may vary in different working temperatures. Therefore, the field service cloud may provide the updates in the threshold limits to the sensor hub via over-the-air technology, and sensor hub accordingly may modify the threshold limit for plurality of sensors. Therefore, the environment of the industrial equipment 101 may be an important factor influencing working of the industrial equipment 101. The different ambient environment factors may be, such as, but not limited to temperature, humidity, light, pH of air and the like. The field service cloud 105 may use over-the-air transmission to provide the configuration updates (for example, but not limited to, change in threshold limits of different ambient environment factors) to the sensor hub 103. According to some embodiments, the field service cloud 105 may transmit the configuration updates to the sensor hub 103 at defined intervals of time. Additionally or alternately, the field service cloud 105 may initiate over-the-air transmission of the configuration updates based on a request received from an authorized personnel. For example, only higher level of field personnel, such as, field manager may be authorized to request the field service cloud 105 to initiate over-the-air transmission of the configuration updates.

Using edge intelligence, the smart sensor hub 103 may transmit only alerts related to exceptions generated in the sensor data to the field service cloud 105. The burden on the field service cloud 105 to process the sensor data in real-time is avoided by the edge intelligence in the smart sensor hub 103. The learning is acquired at the edge by the smart sensor hub 103. The smart sensor hub 103 brings intelligence on edge thereby enabling the dynamic coupling of the monitoring services with the industrial equipment 101. The enhancement of this is achieved through the ML and/or Artificial Intelligence (AI), which in turn capitalizes the sensors 102a-102f connected to industrial equipment 101. The rules for preliminary exception management, may be configured into the smart sensor hub 103. The preliminary exception management may include, determining degree of the exceptions based on the consequences of the generated exceptions. Based on the generated exceptions, the smart sensor hub 103 may generate instructions, such as, one or more alerts comprising instructions to be taken care by the field service cloud 105. The one or more alerts may be generated by cloning a schema of the generated exceptions using digital twin. The schema of the generated exception may comprise information related to the features of the generated exception and organization of the exceptions in a database. Further the digital twining is a process of creating virtual models of a process, product or service. In an embodiment, the data obtained from industrial equipment 101 may help in start building intelligence algorithm that is dynamic to operational environment. The received data is used for making decision based on the ML and/or AI.

The smart sensor hub 103 may communicate with the field service cloud 105 via a network 104, a short range network or a long range network. The network 104 may be, for example, one of a telecommunication network that implements LTE, a communication network that implements Bluetooth® of Bluetooth Sig, Inc., a network that implements Wi-Fi® of Wi-Fi Alliance Corporation, a network that implements LoRa® of Semtech Corporation. The LoRa is a long range network resulting in low power consumption of the smart sensor hub 103. The LoRa network is a secured network, widely used in low cost battery operated IoT applications. In an embodiment, the network 104 may be an ultra-wideband communication network (UWB), a wireless universal serial bus (USB) communication network, a general packet radio service (GPRS) network, a mobile telecommunication network, a local area network, a wide area network, an internet connection network, an infrared communication network, etc., or a network formed from any combination of these networks.

The field service cloud 105 may receive instructions corresponding to the generated exception from the smart sensor hub 103. The field service cloud 105 may perform secondary exception management involving escalation of the generated exceptions and resolution of the generated exceptions by the smart sensor hub 103. Based on the degree of the exception, the field service cloud 105 may route the generated exception to the chatbot application 110 or the IoT application 109 on the user device 108. The user device 108 may be, for example, a personal computer, a tablet computing device, a mobile computer, a mobile phone, a smart phone, a portable computing device, a laptop, a personal digital assistant, a wearable device such as the Google Glass® of Google Inc., the Apple Watch® of Apple Inc., the Android Smartwatch® of Google Inc., etc., a touch centric device, a server, a client device, a portable electronic device, a network enabled computing device, an interactive network enabled communication device, a web browser, any other suitable computing equipment, combinations of multiple pieces of computing equipment, etc.

In an embodiment, the field service cloud 105 may intelligently route an exception of a certain degree to the Chatbot application 110 on the user device 108. The field technician may utilize chatbot application 110 to query the smart sensor hub 103 for the details about the exception, such as, the time stamp of occurrence of the exception, consequences of the exception, etc., and may analyze and resolve the exception by initiating an auto-diagnostic feature of the industrial equipment 101. In an embodiment, the field service cloud 105 may itself initiate an auto-resolution routine in the industrial equipment 101, in case the industrial equipment 101 is smart. Alternatively, the auto-resolution routine may be initiated by a voice command from the field technician. The field service cloud 105 may utilize voice automation to allow the interaction of the field technician with the sensor hub 103 and/or the industrial equipment 101. The field service cloud 105 may raise tickets corresponding to the generated exception in the IoT application 109. The field service cloud 105, in communication with the IoT application 109 on the user device 108, may identify a field agent to attend to the generated exception, in case the exception requires manual interference. Additionally or alternatively, the sensor hub 103 may also raise tickets corresponding to the generated exception based on the degree of the generated exception. According to an example embodiment, the sensor hub 103 may raise tickets independently (i.e. without intervention of the field service cloud 105) for exception whose degree of exception is less than a threshold value. The ticket may comprise, for example, identification number of the industrial equipment 101, the degree of the exception, a type of task needs to be performed to resolve the exception (for example, but not limited to, service, troubleshooting, support, monitoring, etc.), a resolution time within which the exception may need to be resolved, status of the ticket (for example, but not limited to, pending, assigned, resolved) and the like. Further, the field service cloud 105 may obtain the raised ticket from the sensor hub 103 to identify the field agent to attend to the generated exception.

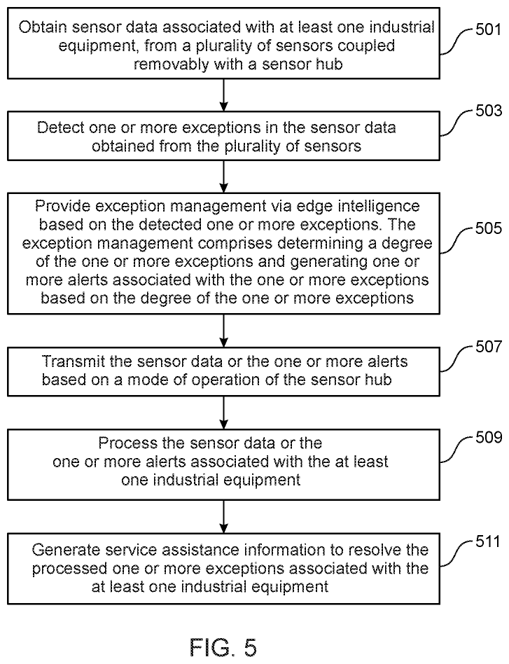

The field service cloud 105 may generate the service assistance information, comprising suggestions, recommendations, troubleshooting manuals, maintenance training, etc., and render the service assistance information as a part of a user interface of the Chatbot application 110 on the user device 108 associated with the field technicians. The Chatbot application 110, based on the analysis of the exception may provide assistance, such as, suggestions, recommendations, etc., to the field technician to resolve the exception generated by the industrial equipment 101. Based on the raised tickets, the field service cloud 105 may select one or more field service agents based on a service profile of the field service agents stored in a distributed ledger 107. The field service cloud 105 may drive the IoT application 109 on the user device 108 associated with the field technicians to allocate the exception to one or more field technicians based on their respective service profile that lists competency, availability, and proximity of the field technicians to the industrial equipment 101 requiring attention. In an embodiment, the IoT application 109 functions along with existing CRM platform employed by the enterprise or CRM platform of the outsourced service providers, such as, technicians, engineers, etc. Details about the field technicians, such as, competency, availability, location, qualifications, etc., may be stored in a distributed ledger 107. The field service cloud 105 may access such details of the field technicians and along with the IoT application 109 may decide the number of field technicians required and an identity of the field technicians. The field service cloud 105 may transmit a service request to the user device 108 of each of the field technicians selected for resolving the exception. The field service cloud 105 may render user interfaces of the IoT application 109 on the user device 108 of the field technicians and platform administrators of the IFSA platform 106 respectively, as shown in FIGS. 5A-5C.

The data for example for the field tickets generated is stored in the distributed ledger 107 may be based on a Hyperledger fabric to provide security assurance. The field service cloud 105 may generate service level agreement compliance reports and perform shift management of the field technicians using the Hyperledger fabric. Based on the entries in the Hyperledger fabric, the field service cloud 105 may rate the field technicians and recommend trainings to the field technicians in smarter resolution of the exceptions. The field service cloud 105 may update the service profiles of the field technicians in the distributed ledger 107. The ratings awarded to the field technicians are also stored in the Hyperledger fabric. A log of the exceptions associated with the industrial equipment 101 may also be maintained in the Hyperledger fabric. The Hyperledger fabric keeps the field ticket based transactions, ratings, allocations, recommendations, etc., between the field service cloud 105 and each of the field technicians confidential and secure.

The combination of the IFSA platform 106 with the applications 109 and 110 on the user device 108 results in a smarter resolution of exceptions generated by the industrial equipment 101, resulting in an implementation of a smartplace 111. An administrator of the IFSA platform 106 may manually code only once for the implementation of the smartplace 111 in a proprietary language and the IFSA platform 106 in communication with the user device 108 implement the smartplace 111, without any interference of the platform administrator. The smartplace 111 driven field operations by the IFSA platform 106 engages field technicians or initiates actuation for resolution of exceptions based on a knowledge base, thereby digitally enabling blended labor model using machine-machine-human interactions. The IFSA platform 106 performs intelligent scheduling of the field technicians and optimizes workforce efficiency based on knowledge and availability of resolution of the exception. The scheduling is based on “location awareness” which is governed by the proximity, availability, and competence of the field service agents in the roster for the shift and the day.

FIG. 2 illustrates an architectural diagram of the smart sensor hub 103 of the IFSA platform 106, in accordance with one or more example embodiments. Please note that for illustrative purpose the smart sensor hub 103 is shown including six connection ports for six sensors for different parameters, however this should not be considered limiting as a person ordinary skilled in the art will appreciate that the smart sensor hub 103 may also include connection ports more or less than six connecting to more or less number of sensors. The smart sensor hub 103 has six connection ports 103a-103f to physically connect the sensors 102a-102f to the smart sensor hub 103. The connection ports 103a-103f of the smart sensor hub 103 enable plug and play of the sensors 102a-102f on-demand. The smart sensor hub 103 may accept any make and type of sensor, such as, 102a-102f. The smart sensor hub 103 may not be driven by particular protocols. That is, the smart sensor hub 103 provides an open sensor solution enabling plug and play of the sensors 102a-102f. The smart sensor hub 103 may sense six different parameters based on the requirements and may accept the sensors 102a-102f of any make and parameter.

The smart sensor hub 103 comprises a transceiver 201, a power source 202, a controller 203, a local memory 204, a communication interface 205, internal sensors, that is, other sensor hardware 206, and a network interface 207 connected via a bus 208. The power source 202 may be a DC power source, such as a rechargeable battery. The life of the rechargeable battery may be five to seven years. In an embodiment, the smart sensor hub 103 may be powered by an external DC power source. The other sensor hardware 206 may be a GPS module to provide the location of the smart sensor hub 103 and other sensors, such as, a temperature sensor, a vibration sensor, etc., to monitor the health condition of the smart sensor hub 103.

The controller 203 may be any of one or more microprocessors, central processing unit (CPU) devices, finite state machines, microcontrollers, digital signal processors, logic, a logic device, a user circuit, an application specific integrated circuit (ASIC), a field-programmable gate array (FPGA), a chip, etc., or any combination thereof, capable of executing computer programs or a series of commands, instructions, or state transitions. The local memory 204 may store program instructions, applications, and data. The local memory 204 is, for example, a random access memory (RAM) or another type of dynamic storage device that stores information and instructions for execution by the controller 203. The local memory 204 may also store temporary variables and other intermediate information used during execution of the instructions by the controller 203. The local memory 204 may further include a read only memory (ROM) or another type of static storage device that stores static information and instructions for the controller 203.

The communication interface 205 is for communicating with the external devices, for example, sensors 102a-102f, input devices, etc. The communication interface 205 may include the connection ports 103a-103f for the connection of the sensors 102a-102f to the smart sensor hub 103 and an Ethernet communication interface. The connection ports 103a-103f may be RJ 45 connection ports that support Ethernet connection. The smart sensor hub 103 may be located at a location closer to the industrial equipment 101 and the sensors 102a-102f may be physically connected to the smart sensor hub 103 using Ethernet cables. The input devices may be, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc., employed by the platform administrator of the IFSA platform 106 to configure or trouble shoot the smart sensor hub 103.

The network interface 207 may enable connection of the smart sensor hub 103 to the network 104. The smart sensor hub 103, via the network 104 may communicate with the field service cloud 105. In an embodiment, the network interface 207 is provided as an interface card also referred to as a “line card” in the smart sensor hub 103. The network interface 207 may include, for example, one or more of an infrared (IR) interface, an interface implementing Wi-Fi® of Wi-Fi Alliance Corporation, a universal serial bus (USB) interface, a FireWire® interface of Apple Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The smart sensor hub 103 may communicate with the network 104 via the transceiver 201, for example, an antenna using the network interface 207.

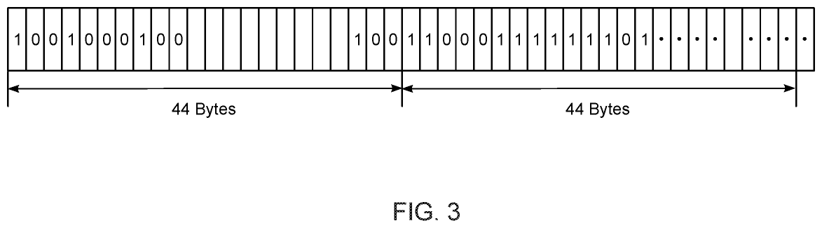

The smart sensor hub 103 may receive the sensor data from the external sensors 102a-102f via the communication interface 205 and the controller 203 may process and analyze the sensor data for any anomaly. The edge intelligence of the smart sensor hub 103 may enable the industrial equipment 101 to be smarter. Based on the mode of operation of the smart sensor hub 103 as configured by the platform administrator as disclosed in the detailed description of FIG. 1, the smart sensor hub 103 may transmit the sensor data with exceptions and instructions to address the exceptions, to the field service cloud 105 via the network 104 through a proprietary schema of 44 bytes size as exemplarily illustrated in FIG. 3. The smart sensor hub 103 enables business continuity with open communication framework supporting different modes of communication, such as, Wi-Fi LTE, LoRa, etc.

FIG. 3 illustrates a schematic diagram of data transmission by the smart sensor hub 103 of the IFSA platform 106, in accordance with one or more example embodiments. The smart sensor hub 103 may transmit the sensor data with exceptions to the field service cloud 105 as a schema of 44 bytes size as exemplarily illustrated. The data in the schema may be encrypted using encryption algorithms employing SHA256 hash function. The secured schematic transmission of the instructions to the field service cloud 105 act as a safeguard against identity risks associated with the industrial equipment 101 or the external sensors 102a-102f.

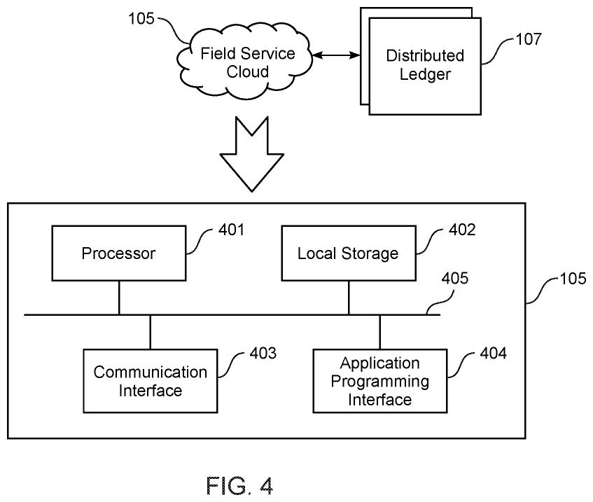

FIG. 4 illustrates an architectural diagram of the field service cloud 105 of the IFSA platform 106, in accordance with one or more example embodiments. The field service cloud 105 may receive instructions corresponding to exceptions from the smart sensor hub 103 and perform a plurality of tasks, such as, raise tickets in the IoT application 109 on the user device 108 of the field technicians, engineers, and business heads, perform the secondary exception management as disclosed in the detailed description of FIG. 1, perform shift management of the field technicians and engineers, generate alerts in the IoT application 109 on the user device 108 of the field technicians, field leads, business heads, etc., intelligently identify appropriate workforce to attend to the exception, and the like.

As exemplarily illustrated in FIG. 4, the field service cloud 105 comprises a processor 401, a local storage 402, a communication interface 403, and an application programming interface (API) 404 connected by a bus 405. The processor 401 may perform the plurality of tasks performed by the field service cloud 105, as disclosed in the detailed description of FIG. 1. The processor 401 may be any of one or more microprocessors, central processing unit (CPU) devices, finite state machines, computers, microcontrollers, digital signal processors, logic, a logic device, a user circuit, an application specific integrated circuit (ASIC), a field-programmable gate array (FPGA), a chip, etc., or any combination thereof, capable of executing computer programs or a series of commands, instructions, or state transitions. In an embodiment, the processor 401 is implemented as a processor set comprising, for example, a programmed microprocessor and a math or graphics co-processor. The processor 401 is selected, for example, from the Intel® processors such as the Itanium® microprocessor or the Pentium® processors, Advanced Micro Devices (AMD®) processors such as the Athlon® processor, UltraSPARC® processors, microSPARC® processors, HP® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The field service cloud 105 disclosed herein is not limited to employing a processor 401.

The local storage 402 may include a non-transitory computer-readable storage medium, for example, a memory unit for storing computer program instructions for the functioning of the field service cloud 105. The non-transitory computer-readable storage medium may be all computer readable media, for example, non-volatile media, volatile media, and transmission media, except for a transitory, propagating signal. Non-volatile media comprise, for example, solid state drives, optical discs or magnetic disks, and other persistent memory volatile media including a dynamic random access memory (DRAM), which typically constitute a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to the processor 401. The memory unit may store program instructions, applications, and data. The memory unit is, for example, a random access memory (RAM) or another type of dynamic storage device that stores information and instructions for execution by the processor 401. The memory unit also stores temporary variables and other intermediate information used during execution of the instructions by the processor 401. The field service cloud 105 may further include a read only memory (ROM) or another type of static storage device that stores static information and instructions for the processor 401.

The communication interface 403 may allow the field service cloud 105 to communicate with external devices, for example, the network 104, input devices, the smart sensor hub 103, the distributed ledger 107, etc. The communication interface 403 may enable connection of the field service cloud 105 to the network 104. In an embodiment, the communication interface 403 is provided as an interface card also referred to as a “line card”. The communication interface 403 may include, for example, one or more of an infrared (IR) interface, an interface implementing Wi-Fi® of Wi-Fi Alliance Corporation, a universal serial bus (USB) interface, a FireWire® interface of Apple Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc.

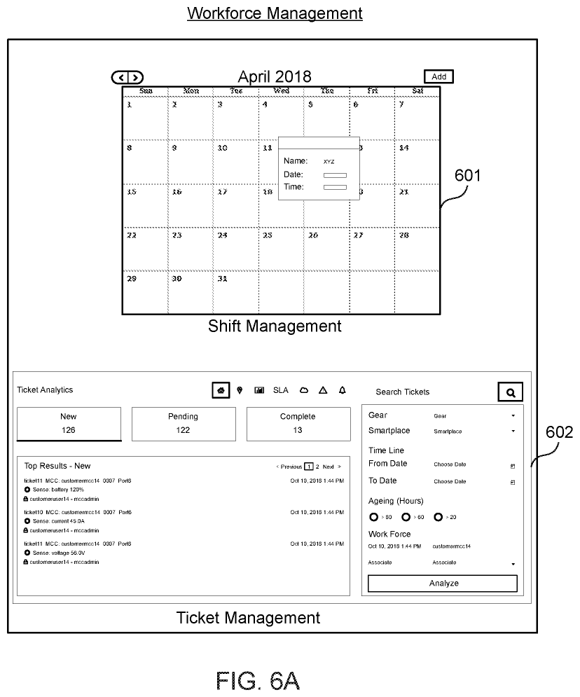

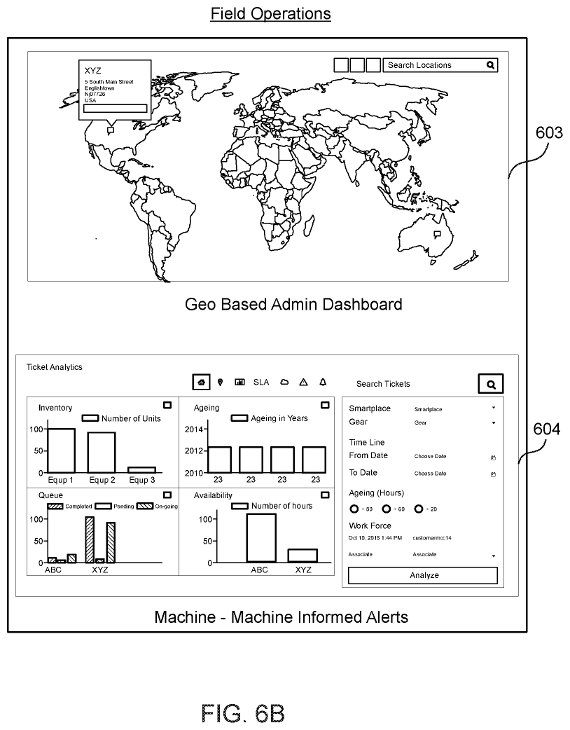

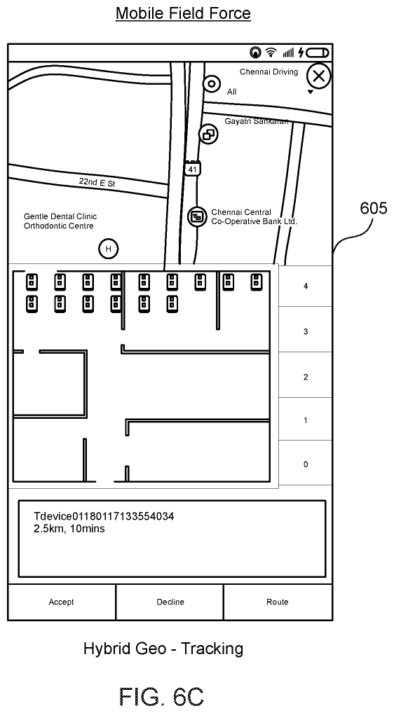

The API 404 of the field service cloud 105 may allow the processor 401 of the field service cloud 105 to generate and render user interfaces in the IoT application 109 on the user device 108 of the field technicians, engineers, etc., as exemplarily illustrated in FIGS. 6A-6C.

FIG. 5 exemplarily illustrates a method 500 for remote monitoring and servicing of at least one industrial equipment, in accordance with an example embodiment. It will be understood that each block of the flow diagram of the method 500 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 204 of the smart sensor hub 103 and the memory 402 of the field service cloud 105, employing an embodiment of the present invention and executed by the controller 203 and the processor 401, respectively. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 500 illustrated by the flow diagram of FIG. 5 for remote monitoring and servicing of at least one industrial equipment 101 may include, at step 501, obtaining sensor data associated with the at least one industrial equipment 101, from a plurality of sensors 102a-102f. At step 503, the method 500 may include detecting one or more exceptions in the sensor data obtained from the plurality of sensors 102a-102f. The plurality of sensors 102a-102f are removably engaged with the sensor hub 103 for remote monitoring of the at least one industrial equipment 101. At step 505, the method 500 may include providing exception management via edge intelligence based on the detected one or more exceptions. The exception management comprises determining a degree of the one or more exceptions. The exception management further comprises generating one or more alerts associated with the one or more exceptions based on the degree of the one or more exceptions. At step 507, the method 500 may include transmitting one or more of the sensor data or the detected one or more exceptions based on a mode of operation of the sensor hub 103 to the field service cloud 105. The field service cloud 105 is communicatively coupled to the sensor hub 103 for servicing of the at least one industrial equipment 101. At step 509, the method 500 may include processing one or more of the sensor data or the one or more alerts associated with the at least one industrial equipment from the sensor hub 104; and at step 511, the method 500 may include generating service assistance information to resolve the processed one or more exceptions associated with the at least one industrial equipment 101.

In an example embodiment, a system for performing the method of FIG. 5 above may comprise a processor (e.g. the controller 203 and the processor 401) configured to perform some or each of the operations (501-511) described above. The processor may, for example, be configured to perform the operations (501-511) by performing hardware implemented logical functions, executing stored instructions, or executing algorithms for performing each of the operations. Alternatively, the system may comprise means for performing each of the operations described above. In this regard, according to an example embodiment, examples of means for performing operations 501-511 may comprise, for example, the controller 203 and the processor 401, and/or a device or circuit for executing instructions or executing an algorithm for processing information as described above.

FIGS. 6A-6C illustrate user interfaces 601, 602, 603, 604, and 605 rendered by the field service cloud 105 on the user device 108, in accordance with one or more example embodiments. As exemplarily illustrated, the field service cloud 105 may perform the tasks of workforce management, field operation management, and field force assistance. The field service cloud 105 may perform shift management of the field force and ticket management of the exceptions. The field service cloud 105 may dynamically allocate the exceptions to the field technicians based on their competency, availability, and proximity to the industrial equipment 101. It shall be noted that although standalone ticketing system is described in the specification for task allocation to the field technician, however it shall not limit the scope of the invention and other task allocation techniques may also be used for allocation of jobs to the field technicians.

The field service cloud 105 may access the distributed ledger 107 for efficient workforce management. The records corresponding to the workforce, such as, ratings of the field technicians, availability of the field technicians, responsiveness of the field technicians, etc., may be securely stored in the distributed ledger 107. In an embodiment, a log of exceptions, a log of raised tickets, etc., may be stored in the distributed ledger 107. The tickets comprise at least one of a request or a complaint corresponding to one or more alerts associated with the at least one industrial equipment. Such records associated with field technicians in the distributed ledger 107 may be edited only by field leads and business heads, thus, ensuring secured transactions in the distributed ledger 107.

The field service cloud 105 may render workforce management user interface 601 and ticket management interface 602 for shift management of workforce and ticket management, respectively on the user device 108 of the administrator of the IFSA platform 106 and the field managers and the business heads. The field service cloud 105 may render the field operation interface 603 and alert interface 604 in the IoT application 109 of the user device 108 for field operation management. The field service cloud 105 may provide a dashboard rendering location of the industrial equipment 101 to be serviced and may generate smart alerts in the IoT application 109.

The field service cloud 105 may generate audible alerts to the user device 108 of the field technicians, field managers, engineers, and business heads. The field service cloud 105 may render the navigation data for the field technician to reach the industrial equipment 101 from their current location on a user interface 605 by geo-tracking of the field technician servicing the industrial equipment 101. On arrival of the field technician at the site of the industrial equipment, the field service cloud 105 platform guides the field technician to the exact location of the industrial equipment, reducing the time to locate the industrial equipment. The field service cloud 105 may utilize a network of beacons and pedometers or mobile GPS based application system to provide navigation data to the field technicians.

Additionally, the field service cloud 105 may utilize an augmented reality (AR) application to provide indoor positioning to track the industrial equipment 101. For example, the field service cloud 105 may provide AR data along with the navigation data on the user interface 605 in real-time for the field technician to track the industrial equipment 101 associated with the generated exceptions. The AR data may comprise virtual arrows, directional pointers, markers or the like. For example, on arrival of the field technician at the site of the industrial equipment 101, the field service cloud 105 may guide the field technician via virtual arrows along the path leading to the industrial equipment 101. According to an example embodiment, the augmented reality (AR) application may be integrated with the IoT application 109 and/or the chatbot application 110 of the user device 108.

According to an example embodiment, the industrial equipment 101 may be stationary and/or may be mobile. For example, the industrial equipment 101 may be a stationary equipment fixed to ground. Further, the industrial equipment 101 may be a mobile equipment which may be in motion, for example, a field robot. Accordingly, the field service cloud 105 may utilize one or more indoor positioning technologies to provide asset tracking. For example, the field service cloud 105 may track the position of the industrial equipment 101 to render the navigation data for the field technician to reach the industrial equipment 101. The indoor positioning technologies may be based on different technologies, for example, but not limited to, Infrared, RFID (radio frequency identification), Bluetooth, Wi-Fi, Li-Fi, Ultrasonic system and the like. For example, an infrared (IR) source and a detection device may be used to detect position of the industrial equipment 101. The IR source associated with a unique number may be installed on the industrial equipment 101 such that IR signals from the IR source may be detected by the detection device. The detection device may determine the position of the industrial equipment 101 associated with the IR source based on the detected IR signals. According to an alternate embodiment, an RFID tag with a unique ID capable of emitting continuous radio frequency signals may be attached to the industrial equipment 101. The detection device may process the radio frequency signal to determine current position of the industrial equipment 101. According to some example embodiments, a network of beacons emitting low-energy Bluetooth signal and pedometers may be used to track the industrial equipment 101. According to another alternate embodiment, Wi-Fi points may be created near the industrial equipment 101. The detector device may be used to determine the position of the industrial equipment 101 based on the signal strength received from the Wi-Fi points. According to an example embodiment, the detection device may be an independent device installed in the environment of the industrial equipment 101 and may relay the determined position of the industrial equipment 101 to the user device 108. Alternatively, the detection device may be part of the user equipment 108.

Further, the field service cloud 105 may use image processing based technology to provide asset tracking (specifically for mobile industrial equipment 101 such as field bots), and render the navigation data to the field technician to reach the industrial equipment 101. The field service cloud 105 may use image processing techniques (object identification or object tracking methods) to construct a machine learning (ML) model for identifying and locating the mobile industrial equipment 101. The ML model is trained by feeding multiple indoor images including the industrial equipment 101 in its designated surrounding. Each industrial equipment 101 is placed in designated area, in case of mobile industrial equipment 101 (i.e. field robots) a designated operating area is specified. Accordingly the ML model may be trained to identify the mobile industrial equipment 101, and to tag the industrial equipment 101 with a unique ID along with a location ID. The unique ID and location ID of the tagged mobile industrial equipment 101 are stored in an image database. The indoor images may be crowd sourced from environments of the industrial equipment 101. Further, each indoor image may be associated with a location tag. The location tag may represent a position associated with the location of industrial equipment 101. The field service cloud 105 may identify the mobile industrial equipment 101 using the trained ML model and obtain its current location and render navigation data to the field technician based on the current location of the industrial equipment 101. Further, the field service cloud 105 may render navigation data to the field technician based on the location tag received from the mobile/stationary industrial equipment 101 associated with the exception. According to some example embodiments, the field service cloud 105 may render the AR data along with the navigation data to the field technician via the user equipment 108.

Further, the field service cloud 105 may utilize augmented reality to render the service assistance information on the user interface 605. The service assistance information may comprise suggestions, recommendations, troubleshooting manuals, maintenance training manuals etc. The maintenance training manuals may provide maintenance training for the field technicians. The maintenance training using augmented reality may help in identifying the exception associated with the industrial equipment 101 and may further provide instructions to the field technician to resolve the identified exception. The maintenance training may provide guidance to the field technician based on a previous exception and/or the present exception generated by the industrial equipment 101. Thus utilization of augmented reality for maintenance training may improve productivity of the field technician and save time involved in resolution of the exception associated with the industrial equipment 101.

The field service cloud 105 may generate and render navigation data on the user device 108 of the selected field service agent to service the industrial equipment 101. The field service 105 may provide navigational assistance to the field technician to reach the industrial equipment 101 in the form of the user interface 605. The field service cloud 105 may render a map interface on the user device 108 of the field technician to guide him/her to reach the industrial equipment 101. The field service cloud 105 may in real-time track the position of the field technician and by using the GPS module of the smart sensor hub 103 may guide the field technician to reach the industrial equipment 101 in real-time. In an embodiment, the field service cloud 105 may provide the field technician with technical assistance to handle the exception generated by the industrial equipment 101. In an embodiment, the field service cloud 105 may perform analysis of the exceptions and generates visualization based on the analysis in the IoT application 109 of the user device 108. Such analytics may be used for preventive maintenance of the industrial equipment 101. In an embodiment, such analytics may be used by the platform administrator of the IFSA platform 106 to train the machine learning engine in the smart sensor hub 103 in identifying exceptions and predictive maintenance of the industrial equipment 101.

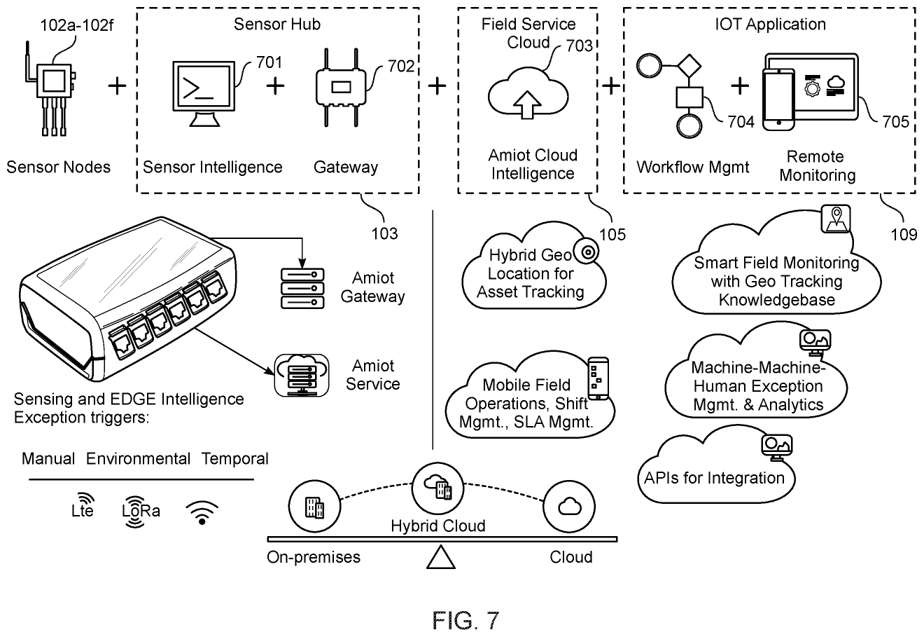

FIG. 7 illustrates a schematic diagram for implementation of smartplace 111 using the IFSA platform 106, in accordance with one or more example embodiments. As exemplarily illustrated, the sensor nodes or the sensors 102a-102f may be connected to the industrial equipment 101. The other end of the sensors 102a-102f may be connected to the smart sensor hub 103 with edge intelligence 701 and networking capabilities. The gateway 702 in the smart sensor hub 103 may provide the networking capabilities to the smart sensor hub 103 to communicate with the field service cloud 105 via the network 104 as disclosed in the detailed description of FIG. 1. The smart sensor hub 103 may communicate the instructions to the field service cloud 105. The field service cloud 105 with cloud intelligence 703 may perform workflow management 704 and remote monitoring 705 of the industrial equipment 101 in the IoT application 109 on the user device 108. The smart sensor hub 103 may function in different modes, such as, the manual mode, the environmental mode, and the temporal mode as disclosed in the detailed description of FIG. 1. The field service cloud 105 may provide hybrid geo-location for tracking of location of the field technicians and the industrial equipment 101, smart field monitoring with geo-tracking and knowledge database, mobile field operation management, shift management, SLA management, and exception management. The SLA management by the field service cloud 105 may allow the business heads to track efficiency of their sub-ordinates and monitor the quality of work being delivered, thus influencing the business plans of the enterprise. Such an implementation of the IFSA platform 106 in communication with an IoT application 109 aids in creation of remote monitoring centers in enterprises.

The IFSA platform 106 in communication with the IoT application 109 provides an improvement in the technology of field service operation management as follows: The smart sensor hub 103 performs green power management. That is, the smart sensor hub 103 functions on a 5V DC power supply, for example solar power, thus reducing damage to the environment. The smart sensor hub 103 has exception or sensor edge intelligence 701 and is designed for retrofitting. The sensors 102a-102f may be dynamically plugged and configured, limiting incompatibility issues. The field service cloud 105 may provide hybrid geo-fencing, aiding in detection of intrusion in the smartplace 111. The field service cloud 105 may provide precision location management of the field technicians and the industrial equipment 101. The IFSA platform 106 allows remote monitoring of the industrial equipment 101. The IFSA platform 106 is cross-industry compatible and scalable. The IFSA platform 106 may be integrated to the existing CRM and ERP platform of the enterprise. The field service cloud 105 has APIs for integration with complementary enterprise applications. The workforce management by the field service cloud 105 provides optimized field and facility services. With the workforce management, the service operations gain efficiency with improved staff utilization, exception management, and trouble ticket handling. The IFSA platform 106 is an evolving platform incorporating latest technology advancements. The IFSA platform 106 may be integrated with IoT-enabled sensors. The implementation of a smartplace 111 facilitates onboarding of sensors and devices. The remote monitoring and control capability of the IFSA platform 106 provides secure monitoring and control of the industrial equipment, such as, 101 with geolocation. The IFSA platform 106 performs advanced visualization and predictive analysis of the sensor data.

The combination of the smart sensor hub 103 which is an on premise component of the IFSA platform 106, and the field service cloud 105 which is a cloud component of the IFSA platform 106 results in the IFSA platform 106 to be a hybrid cloud implementation. In an embodiment, the IFSA platform 106 may be implemented in client-server architecture, with the client at the location of the industrial equipment 101 and the server may be physically present remotely from the client.

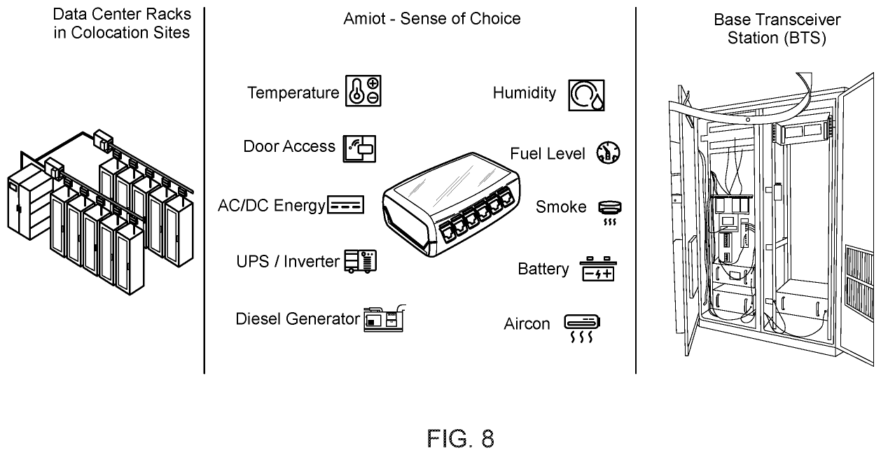

FIG. 8 illustrates a schematic diagram showing different applications of the industrial field services automation (IFSA) platform, in accordance with one or more example embodiments. As exemplarily illustrated, the combination of the IFSA platform 106 and the IoT application 109 is implemented in monitoring of data center racks in colocation sites and a base transceiver station in a broadband center of a telecom enterprise. In the data center racks, the IFSA platform 106 finds application in temperature and humidity monitoring for field service management in the data centers. The sensors 102a-102f may capture all relevant environmental and access parameters in the data center. In the data center racks, the sensors may detect vibrations, such as, as from earthquakes or damaged fans along three axes, the sensors may monitor cool air entering and/or hot air being expelled, and ensure proper containment, at the front and rear of the rack. Additionally, the sensors may meter airflow in plenum space, such as, under a raised floor, or just above the perforated tiles, the sensors may detect leaks on the floor, around an area, on liquid cooled racks, and may detect condensation. The sensors may further meter differential air pressure above and below a raised floor, or between hot aisles and cold aisles to prevent thermal leaks. Dual contact closure may be used with third-party sensors, such as, smoke detectors, magnetic door locks, or to trigger webcams whenever a cabinet door is opened. The smart sensor hub 103 and the field service cloud 105 may analyze the sensor data in real-time to provide operational inputs to the field technicians, the field mangers, and the business heads. The field service cloud 105 may help the business head with predictive actionable insights based on continual performance analysis. Such predictive actionable insights may reduce downtime and outage through preventive actions based on the insights.

The field service cloud 105 may authorize entry of field technicians to service the data center racks. The field service cloud 105 may be authorized using low energy Bluetooth (BLE), based on an exchange of tokens between the user device 108 in possession of the field technician and the industrial equipment 101. The exchange of tokens is maintained in the distributed ledger 107. Without human interference, machine-machine interaction between the user device 108 in possession of the field technician and the industrial equipment 101 allows for secure access of the industrial equipment 101.

In the location of a base transceiver station, the field service cloud 105 of the IFSA platform 106 may generate real-time status update and early warning of oncoming issues. The smart sensor hub 103, in communication with the field service cloud 105, may trigger an alert when a threshold is exceeded. The field service cloud 105 may remotely troubleshoot the distressed industrial equipment 101. Using the automated trouble ticketing by the field service cloud 105 of the IFSA platform 106, the productivity of the broadband center of a telecom enterprise will increase and the operating costs are reduced. The field service cloud 105 creates service tickets to schedule field technician follow-ups. The field service cloud 105 assigns tasks based on criteria, such as, work shifts, experience level, and proximity to the location of the base transceiver station, as available in the distributed ledger 107. The IFSA platform 106 may ensure network reliability at the location of the base transceiver station with remote visibility. The IFSA platform 106 aids in identifying problems at the base transceiver station before they disrupt network service and the IFSA platform 106 manages all sensor data at the at the base transceiver station and gets actionable results more efficiently. The IFSA platform 106 monitors stand-by power source, such as, the diesel generator or the UPS/inverter or battery at the location of the base transceiver station to ensure performance. The IFSA platform 106 supports battery maintenance program, and performs standby generator management and Time-to-failure analytics at the location of the base transceiver station.

The IFSA platform 106 finds applications in the areas of protection and security of residential and security building too. The IFSA platform 106 protects the buildings against catastrophic events, such as, water damage, humidity damage, carbon monoxide poisoning, etc. In improving the security at the location of buildings, the IFSA platform 106 detects and alerts against unauthorized entry into the buildings. The sensors 102a-102f and the smart sensor hub 103 may monitor various parameters, such as, temperature, humidity, water leakage, carbon monoxide, natural gas, closure of doors and windows. The IFSA platform 106 results in increase in the safety and security of the property and the occupants, increase in property value and reduction in insurance premiums, and may obtain visibility and actionable information related to the buildings.

The present technology may have the following configurations:

(1) A system for remote monitoring and servicing of at least one industrial equipment, the system comprising a sensor hub removably coupled with a plurality of sensors, and a field service platform communicatively coupled to the sensor hub, the sensor hub comprising a first circuitry configured to: obtain sensor data associated with the at least one industrial equipment, from the plurality of sensors; detect one or more exceptions in the sensor data obtained from the plurality of sensors; determine a degree of the one or more exceptions; provide exception management via edge intelligence, by generation of one or more alerts associated with the one or more exceptions, based on the degree of the one or more exceptions; and transmit the sensor data or the one or more alerts based on a mode of operation of the sensor hub; the field service platform comprising a second circuitry configured to: process the sensor data or the one or more alerts received from the sensor hub; and generate service assistance information to resolve the one or more alerts associated with the at least one industrial equipment.

(2) The system according to (1) above, wherein to generate the one or more alerts, the first circuitry is further configured to clone schema of the detected one or more exceptions using digital twinning.

(3) The system according to (1) above, wherein to generate the service assistance information, the second circuitry is configured to: generate one or more tickets corresponding to the processed one or more alerts associated with the at least one industrial equipment; and select a field service agent corresponding to the generated one or more tickets based on a service profile of the field service agent stored in a distributed ledger.

(4) The system according to (3) above, wherein the second circuitry is further configured to provide information related to the detected one or more exceptions to the selected field service agent, wherein the information comprises at least one of a time stamp of occurrence of the detected one or more exceptions or a consequence of the detected one or more exceptions.

(5) The system according to (4) above, wherein the information related to the detected one or more exceptions is provided to the selected field service agent through a chatbot application on one or more user devices associated with the selected field service agent based on a query from the selected field service agent.

(6) The system according to (3) above, wherein the second circuitry is further configured to generate navigation data on one or more user devices associated with the selected field service agent to navigate a location of the at least one industrial equipment detected with the one or more exceptions; and render the navigation data and the service assistance information on a user interface of each of the one or more user devices associated with the selected field service agent.

(7) The system according to (6) above, wherein the second circuitry is further configured to render augmented reality (AR) data, the navigation data and the service assistance information on the user interface using an AR application on each of the one or more user devices associated with the selected field service agent.

(8) The system according to (3) above, wherein the second circuitry is further configured to update the service profile of the field service agent, corresponding to the generated one or more tickets, in the distributed ledger.

(9) The system according to (8) above, wherein the distributed ledger comprises data based on a Hyperledger fabric.

(10) The system according to (1) above, wherein the service assistance information comprises at least one of suggestions, recommendations, troubleshooting manuals or maintenance training manuals associated with the one or more alerts.

(11) The system according to (1) above, wherein the second circuitry is further configured to generate at least one of a workforce management interface, a ticket management interface, an alert interface, or a field operations interface.

(12) The system according to (1) above, wherein the second circuitry is further configured to initialize a routine for auto-resolution of the detected one or more exceptions associated with the at least one industrial equipment.

(13) The system according to (12) above, wherein the routine for auto-resolution is initiated based on a voice command received from the selected field service agent.

(14) The system according to (1) above, wherein the second circuitry is further configured to transmit configuration updates to the sensor hub based on a request from an authorized personnel, wherein the configuration updates comprise a threshold limit associated with the sensor hub.

(15) The system according to (1) above, wherein the second circuitry is further configured to transmit, using over-the-air (OTA) technology, at least one configuration update to the sensor hub based on a request from an authorized personnel, wherein the at least one configuration update comprises one of an update to threshold limits, an update to instructions associated with the sensor hub, or an update of software running at the sensor hub.

(16) A method for providing remote monitoring and servicing of at least one industrial equipment, the method comprising obtaining sensor data associated with the at least one industrial equipment, from a plurality of sensors coupled removably with a sensor hub; detecting one or more exceptions in the sensor data obtained from the plurality of sensors; determining a degree of the one or more exceptions; providing exception management via edge intelligence, by generating one or more alerts associated with the one or more exceptions based on the degree of the one or more exceptions; transmitting the sensor data or the one or more alerts based on a mode of operation of the sensor hub; processing the sensor data or the one or more alerts associated with the at least one industrial equipment; and generating service assistance information to resolve the processed one or more exceptions associated with the at least one industrial equipment.

(17) The method according to (16) above, wherein generating the one or more alerts further comprises cloning schema of the detected one or more exceptions using the digital twinning.

(18) The method according to (16) above, wherein generating the service assistance information further comprises generating one or more tickets corresponding to the processed one or more alerts associated with the at least one industrial equipment, and selecting a field service agent corresponding to the generated one or more tickets based on a service profile of the field service agent stored in a distributed ledger.

(19) The method according to (18) above, further comprising providing information related to the detected one or more exceptions to the selected field service agent, wherein the information comprises at least one of: a time stamp of an occurrence of the detected one or more exceptions or a consequence of the detected one or more exceptions; and initiating an auto-diagnosis of the industrial equipment based on a response of the field service agent.

(20) The method according to (19) above, wherein the information related to the detected one or more exceptions is provided to the selected field service agent through a chatbot application on one or more user devices associated with the selected field service agent based on a query from the selected field service agent.

(21) The method according to (18) above, further comprising generating navigation data on one or more user devices associated with the selected field service agent to navigate to a location of the at least one industrial equipment detected with the one or more exceptions; and rendering the navigation data and the service assistance information on a user interface of each of the one or more user devices associated with the selected field service agent.

(22) The method according to (21) above, further comprising rendering augmented reality (AR) data, the navigation data and the service assistance information on the user interface using an AR application on each of the one or more user devices associated with the selected field service agent.

(23) The method according to (18) above, further comprising updating the service profile of the field service agent, corresponding to the generated one or more tickets, in the distributed ledger.

(24) The method according to (23) above, wherein the distributed ledger comprises data based on a Hyperledger fabric.

(25) The method according to (16) above, wherein the service assistance information further comprises one or more of suggestions, recommendations, troubleshooting manuals or maintenance training manuals associated with the one or more processed exceptions.

(26) The method according to (16) above, further comprising generating at least one of a workforce management interface, a ticket management interface, an alert interface, or a field operations interface.

(27) The method according to (16) above, further comprising initializing a routine for auto-resolution of the one or more exceptions in the at least one industrial equipment.

(28) The method according to (27) above, wherein the routine for auto-resolution is initiated based on a voice command received from the selected field service agent.

(29) The method according to (16) above, further comprising transmitting configuration updates to the sensor hub based on a request from an authorized personnel, wherein the configuration updates comprise a threshold limit associated with the sensor hub.

(30) A computer programmable product comprising a non-transitory computer readable medium having stored thereon computer executable instructions, which when executed by one or more processors, cause the one or more processors to carry out operations for remote monitoring and servicing of at least one industrial equipment, the operations comprising: obtaining sensor data associated with the at least one industrial equipment, from a plurality of sensors coupled removably with a sensor hub; detecting one or more exceptions in the sensor data obtained from the plurality of sensors; determining a degree of the one or more exceptions; providing exception management via edge intelligence by generating one or more alerts associated with the one or more exceptions based on the degree of the one or more exceptions; transmitting the sensor data or the one or more alerts based on a mode of operation of the sensor hub; processing the sensor data or the one or more alerts associated with the at least one industrial equipment; and generating service assistance information to resolve the processed one or more exceptions associated with the at least one industrial equipment.

(31) The computer program product according to (30) above, wherein generating the service assistance information further comprises: generating one or more tickets corresponding to the processed one or more alerts associated with the at least one industrial equipment, and selecting the field service agent corresponding to the generated one or more tickets based on a service profile of the field service agent stored in a distributed ledger.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for remote monitoring and servicing of at least one industrial equipment, the system comprising:
a sensor hub removably coupled with a plurality of sensors, the sensor hub comprising a first circuitry configured to:
obtain sensor data associated with the at least one industrial equipment, from the plurality of sensors;
detect one or more exceptions in the sensor data obtained from the plurality of sensors;
determine a degree of the one or more exceptions;
provide exception management via edge intelligence, by generation of one or more alerts associated with the one or more exceptions, based on the degree of the one or more exceptions; and
transmit the sensor data or the one or more alerts based on a mode of operation of the sensor hub; and
a field service platform communicatively coupled to the sensor hub, the field service platform comprising a second circuitry configured to:
process the sensor data or the one or more alerts received from the sensor hub; and
generate service assistance information to resolve the one or more alerts associated with the at least one industrial equipment.

2. The system of claim 1, wherein to generate the one or more alerts, the first circuitry is further configured to clone schema of the detected one or more exceptions using digital twinning.

3. The system of claim 1, wherein to generate the service assistance information, the second circuitry is configured to:
generate one or more tickets corresponding to the processed one or more alerts associated with the at least one industrial equipment; and
select a field service agent corresponding to the generated one or more tickets based on a service profile of the field service agent stored in a distributed ledger.

4. The system of claim 3, wherein the second circuitry is further configured to provide information related to the detected one or more exceptions to the selected field service agent, wherein the information comprises at least one of a time stamp of occurrence of the detected one or more exceptions or a consequence of the detected one or more exceptions.

5. The system of claim 4 wherein the information related to the detected one or more exceptions is provided to the selected field service agent through a chatbot application on one or more user devices associated with the selected field service agent based on a query from the selected field service agent.

6. The system of claim 3, wherein the second circuitry is further configured to:
generate navigation data on one or more user devices associated with the selected field service agent to navigate a location of the at least one industrial equipment detected with the one or more exceptions; and
render the navigation data and the service assistance information on a user interface of each of the one or more user devices associated with the selected field service agent.

7. The system of claim 6, wherein the second circuitry is further configured to render augmented reality (AR) data, the navigation data and the service assistance information on the user interface using an AR application on each of the one or more user devices associated with the selected field service agent.

8. The system of claim 3,
wherein the second circuitry is further configured to update the service profile of the field service agent, corresponding to the generated one or more tickets, in the distributed ledger, and
wherein the distributed ledger comprises data based on a hyperledger fabric.

9. The system of claim 1, wherein the service assistance information comprises at least one of suggestions, recommendations, troubleshooting manuals or maintenance training manuals associated with the one or more alerts.

10. The system of claim 1, wherein the second circuitry is further configured to initialize, a routine for auto-resolution of the detected one or more exceptions associated with the at least one industrial equipment, based on a voice command received from the selected field service agent.

11. The system of claim 1,
wherein the second circuitry is further configured to transmit configuration updates to the sensor hub based on a request from an authorized personnel, and
wherein the configuration updates comprise a threshold limit associated with the sensor hub.

12. The system of claim 1, wherein the second circuitry is further configured to:
transmit, using over-the-air (OTA) technology, at least one configuration update to the sensor hub based on a request from an authorized personnel,
wherein the at least one configuration update comprises one of an update to threshold limits, an update to instructions associated with the sensor hub, or an update of software running at the sensor hub.

13. A method for providing remote monitoring and servicing of at least one industrial equipment, the method comprising:
obtaining sensor data associated with the at least one industrial equipment, from a plurality of sensors coupled removably with a sensor hub;
detecting one or more exceptions in the sensor data obtained from the plurality of sensors;
determining a degree of the one or more exceptions;
providing exception management via edge intelligence, by generating one or more alerts associated with the one or more exceptions based on the degree of the one or more exceptions;
transmitting the sensor data or the one or more alerts based on a mode of operation of the sensor hub;
processing the sensor data or the one or more alerts associated with the at least one industrial equipment; and
generating service assistance information to resolve the processed one or more exceptions associated with the at least one industrial equipment.

14. The method of claim 13, wherein generating the one or more alerts further comprises cloning schema of the detected one or more exceptions using the digital twinning.

15. The method of claim 13, wherein generating the service assistance information further comprises:
generating one or more tickets corresponding to the processed one or more alerts associated with the at least one industrial equipment, and
selecting a field service agent corresponding to the generated one or more tickets based on a service profile of the field service agent stored in a distributed ledger.

16. The method of claim 15, further comprising:
providing information related to the detected one or more exceptions to the selected field service agent, wherein the information comprises at least one of: a time stamp of an occurrence of the detected one or more exceptions or a consequence of the detected one or more exceptions; and
initiating an auto-diagnosis of the industrial equipment based on a response of the field service agent.

17. The method of claim 16, wherein the information related to the detected one or more exceptions is provided to the selected field service agent through a chatbot application on one or more user devices associated with the selected field service agent based on a query from the selected field service agent.

18. The method of claim 15, further comprising:
generating navigation data on one or more user devices associated with the selected field service agent to navigate to a location of the at least one industrial equipment detected with the one or more exceptions; and
rendering the navigation data and the service assistance information on a user interface of each of the one or more user devices associated with the selected field service agent.

19. The method of claim 18, further comprising rendering augmented reality (AR) data, the navigation data and the service assistance information on the user interface using an AR application on each of the one or more user devices associated with the selected field service agent.

20. A computer programmable product comprising a non-transitory computer readable medium having stored thereon computer executable instructions, which when executed by one or more processors, cause the one or more processors to carry out operations for remote monitoring and servicing of at least one industrial equipment, the operations comprising:
obtaining sensor data associated with the at least one industrial equipment, from a plurality of sensors coupled removably with a sensor hub;
detecting one or more exceptions in the sensor data obtained from the plurality of sensors;
determining a degree of the one or more exceptions;
providing exception management via edge intelligence by generating one or more alerts associated with the one or more exceptions based on the degree of the one or more exceptions;
transmitting the sensor data or the one or more alerts based on a mode of operation of the sensor hub;
processing the sensor data or the one or more alerts associated with the at least one industrial equipment; and
generating service assistance information to resolve the processed one or more exceptions associated with the at least one industrial equipment.
